(19) United States
(12) Patent Application Publication
(10) Pub. No.: US 2017/0097434 A1
(43) Pub. Date: Apr. 6, 2017

(54) METHODS AND DATA PROCESSING APPARATUS FOR COOPERATIVE DE-NOISING OF MULTI-SENSOR MARINE SEISMIC DATA

(71) Applicant: CGG SERVICES SA, Massy Cedex (FR)

(72) Inventors: Can PENG, Fulshear, TX (US); Hongzheng JIN, Katy, TX (US); Ping WANG, Sugar Land, TX (US)

(73) Assignee: CGG SERVICES SA, Massy Cedex (FR)

(21) Appl. No.: 15/127,890

(22) PCT Filed: Mar. 27, 2015
(86) PCT No.: PCT/IB2015/000537

§ 371 Date: Sep. 21, 2016

Related U.S. Application Data
(60) Provisional application No. 61/971,576, filed on Mar. 28, 2014.

(51) Int. Cl. G01V 1/36; G01V 1/32

(52) U.S. Cl. CPC G01V 1/364; G01V 1/32; G01V 2210/56; G01V 2210/48; G01V 1/38

(57) ABSTRACT

Method and data processing apparatus are used to process seismic data, including pressure data and sensor-acquired acceleration or sensor-acquired velocity data as acquired simultaneously by multi-component sensors in streamers. Equivalent acceleration data is obtained from the pressure data and used as references for de-noising the sensor-acquired acceleration data.

### CROSS REFERENCE TO RELATED APPLICATIONS

This application claims priority and benefit from U.S. Provisional Patent Application No. 61/971,576, filed Mar. 28, 2014, for “NOISE ATTENUATION FOR MULTI-SENSOR DATA VIA COOPERATIVE DE-NOISING,” the contents of which is incorporated in its entirety herein by reference.

### BACKGROUND

Technical Field

Embodiments of the subject matter disclosed herein generally relate to processing marine seismic data acquired using multi-sensor receivers housed by streamers or, more specifically, to using the less noisy pressure data to de-noise the noisier accelerometer or velocity data.

Discussion of the Background

Marine seismic surveys are an efficient manner of exploring the presence of gas and oil reservoirs under the seafloor. Seismic surveys of sedimentary rock formations exploit variations of seismic wave propagation velocity from one layer to another to extract information about the formation's structure. Reflected, refracted and transmitted waves emerging from the formation are detected by seismic receivers. In marine seismic data, the primary signals from the formation under the seafloor are mixed with ghosts (i.e., signals reflected at the water surface).

Multi-sensor receivers housed by streamers are configured to record pressure and three-dimensional (3D) acceleration or velocity data simultaneously. Such a multi-sensor receiver may include a hydrophone and a 3D acceleration or velocity sensor. The use of the multi-sensor receivers has enabled improved de-ghosting and cross-line interpolation in marine seismic data processing. The ghosts in pressure (p) data have opposite polarity than primary signals, but ghosts for vertical acceleration (a₂) or vertical velocity (v_{z}) data have the same polarity as primary signals.

A conventional method of de-ghosting, which is considered stable and accurate, is described in the article, “Attenuation of water-column reverberations using pressure and velocity detectors in a water bottom cable,” by Barr et al., published in 59^{th} SEG Annual Meeting 1989, pp. 653-655, the contents of which is incorporated in its entirety herein by reference. De-ghosting and interpolation may be simultaneously achieved using p, a_{z} and a_{y} as described in the article, “Crossline wavefield reconstruction from multicomponent streamer data part 2—joint interpolation and 3D up/down separation by generalized matching pursuit,” by Ozbek et al. (published in Geophysics, Vol. 75, No. 6, pp. WB69-WP85, 2010), the contents of which is incorporated in its entirety herein by reference. While these methods work well for data acquired when the multi-sensor receivers (e.g., ocean bottom nodes (OBNs)) are placed on the seafloor, they are not adequate for streamer data (i.e., when the multi-sensor receivers are housed on towed streamers). Streamer accelerometer/velocity data are characterized by a low signal-to-noise ratio (SNR). The strong noise is mainly due to mechanical disturbances, such as cable bending and vibrations, which are absent when the receivers are placed on the seafloor. Ignoring this strong noise degrades the results of joint de-ghosting and interpolation.

Pressure data (e.g., recorded by a hydrophone) has better SNR than accelerometer data. In seismic processing of OBN data, pressure data may be used as a reference to perform de-noising and wavelet matching in a selected transform domain. Such methods are described, for example, in the articles, “Ocean bottom seismic noise attenuation using local attribute matching filter,” by Yu et al., published in SEG Technical Program Expanded Abstract, 30, pp. 3586-3590, 2011; “Sparse τ-p Z-noise attenuation for ocean-bottom data,” by Poole et al., published in SEG Technical Program Expanded Abstracts, 31, pp. 1-5, 2012; and “Shear noise attenuation and PZ matching for OBN data with a new scheme of complex wavelet transform,” by Peng et al., published in SEG Technical Expanded Abstracts, 32, pp. 4251-4255, 2013. The contents of these articles are incorporated in their entirety herein by reference. These methods assume that the up-going and down-going waves are well-separated in the transform domain (e.g., directional complex wavelet transform domain, sparse τ-P domain). If the data is acquired with multi-sensor receivers placed on the seafloor, the erroneous attenuation cause by a polarity difference of the down-going wave in p and a_{z} is negligible.

However, different from OBN data (i.e., acquired with multi-sensor receivers placed on the seafloor), in streamer data (i.e., acquired using multi-component receivers towed in streamers), up-going (primaries) and down-going (ghosts) are heavily mixed. Therefore, the a_{z} signal extracted (de-noised) from streamer data using p as a reference (i.e., under the assumption of energy cancellation in pressure data due to coincidence of up-going and down-going waves) is distorted.

Accordingly, it is desirable to develop noise attenuation methods usable for processing streamer data that avoid the drawbacks and overcome the limitations of conventional methods.

### SUMMARY

Noise attenuation methods usable for processing streamer data (i.e., data acquired by multi-sensors towed by streamers, including pressure data and 3D acceleration or velocity data) convert pressure data to equivalent acceleration or velocity data. In the equivalent data, the desired (primary) signal has the same polarity and substantially similar amplitude as the primary signal included in the sensor-acquired data. Therefore the equivalent data and the sensor-acquired data are de-noised cooperatively.

According to an embodiment, there is a noise attenuation method. The method includes obtaining seismic data including pressure data and sensor-acquired acceleration or sensor-acquired velocity data as acquired simultaneously by multi-component sensors in streamers. The method further includes converting the pressure data into equivalent acceleration data. The method also includes de-noising the sensor-acquired acceleration or the sensor-acquired velocity data using the equivalent acceleration data.

According to another embodiment there is a data processing apparatus including an interface and a data processing unit. The interface is configured to obtain seismic data including pressure data and sensor-acquired acceleration or sensor-acquired velocity data as acquired simultaneously by multi-component sensors in streamers. The data processing unit is configured to convert the pressure data into equivalent acceleration data, and to de-noise the sensor-acquired acceleration or the sensor-acquired velocity data using the equivalent acceleration data.

According to yet another embodiment, there is computer readable recording medium (1006) non-transitorily storing executable codes which, when executed on a computer make the computer perform a noise attenuation method. The method includes obtaining seismic data including pressure data and sensor-acquired acceleration or sensor-acquired velocity data as acquired simultaneously by multi-component sensors in streamers. The method further includes converting the pressure data into equivalent acceleration data. The method also includes de-noising the sensor-acquired acceleration or the sensor-acquired velocity data using the equivalent acceleration data.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a flow diagram of a noise attenuation method, according to an embodiment;

FIG. 2 illustrates a shot gather of equivalent a_{z} data obtained from pressure data according to an embodiment;

FIG. 3 illustrates the corresponding sensor-acquired a_{z} data;

FIG. 4 illustrates the de-noised sensor-acquired a_{z} data according to an embodiment;

FIG. 5 illustrates the removed noise;

FIG. 6 is a graph illustrating spectra of sensor-acquired a_{z} data before de-noising and after de-noising according to an embodiment;

FIG. 7 illustrates a shot gather of equivalent a_{y} data obtained from pressure data according to an embodiment;

FIG. 8 illustrates the corresponding sensor-acquired a_{y} data;

FIG. 9 illustrates the de-noised sensor-acquired a_{y} data according to an embodiment; and

FIG. 10 is a schematic diagram of a data-processing apparatus according to an embodiment.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed with regard to marine seismic data processing. However, similar embodiments may be used for land data processing, when data is acquired using buried multi-sensor receivers (e.g., co-denoise may be carried out among different components of geophones).

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

In order to de-noise three-dimensional (3D) accelerometer or velocity data acquired simultaneously with pressure data, the pressure data is converted into equivalent acceleration or velocity data. Since the equivalent data and the sensor-acquired data include the same signal, a cooperative de-noising method is applied.

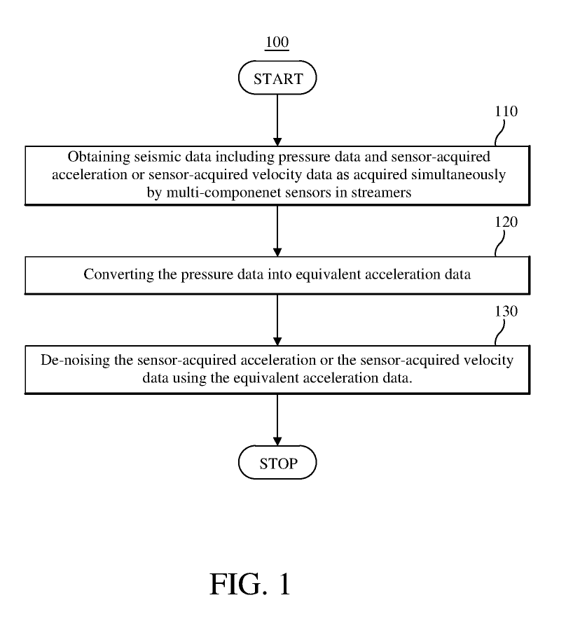

FIG. 1 is a flowchart of a noise attenuation method 100, according to an embodiment. Although method 100 refers to “seismic data” it should be understood that the seismic data is not limited to real data, but seismic data include data simulated based on models (including sensor models used to generate data corresponding to pressure data, sensor-acquired acceleration and/or sensor-acquired velocity data) or a combination of real and simulated/model-based data.

Method 100 includes obtaining the seismic data including pressure data and sensor-acquired acceleration or sensor-acquired velocity data, which represent data simultaneously acquired by multi-component sensors in streamers, at 110. The seismic data may be processed immediately after acquisition to attenuate the noise in the sensor-acquired acceleration or velocity data. Alternatively, the seismic data is stored and assembled to be later processed.

Method 100 further includes converting the pressure data into equivalent acceleration data at 120. The relationship between pressure, p, and acceleration, ā, at any given point can be expressed by the following equation:

\vec{∇}p=−ρā (1)

The detected pressure and 3D acceleration may be decomposed into plane waves as:

$$\begin{matrix}p ( t , x , y , z ) = {\sum }_{ω} {\sum }_{{k}_{x}} {\sum }_{{k}_{y}} ( A ( ω , {k}_{x} , {k}_{y} ) {e}^{i ( ω t - {k}_{x} x - {k}_{y} y + {k}_{z} z )} - R ( ω , {k}_{x} , {k}_{y} ) A ( ω , {k}_{x} , {k}_{y} ) {e}^{i ( ω t - {k}_{x} x - {k}_{y} y - {k}_{z} z )} {e}^{- i 2 {k}_{z} d} ) & ( 2 ) \\ {a}_{z} ( t , x , y , z ) = {\sum }_{ω} {\sum }_{{k}_{x}} {\sum }_{{k}_{y}} - i \frac{{k}_{z}}{ρ} ( A ( ω , {k}_{x} , {k}_{y} ) {e}^{i ( ω t - {k}_{x} x - {k}_{y} y + {k}_{z} z )} + R ( ω , {k}_{x} , {k}_{y} ) A ( ω , {k}_{x} , {k}_{y} ) {e}^{i ( ω t - {k}_{x} x - {k}_{y} y - {k}_{z} z ) {e}^{- i 2 {k}_{z} d}} ) & ( 3 ) \\ {a}_{x} ( t , x , y , z ) = {\sum }_{ω} {\sum }_{{k}_{x}} {\sum }_{{k}_{y}} i \frac{{k}_{x}}{ρ} ( A ( ω , {k}_{x} , {k}_{y} ) {e}^{i ( ω t - {k}_{x} x - {k}_{y} y + {k}_{z} z )} - R ( ω , {k}_{x} , {k}_{y} ) A ( ω , {k}_{x} , {k}_{y} ) {e}^{i ( ω t - {k}_{x} x - {k}_{y} y - {k}_{z} z )} {e}^{- i 2 {k}_{z} d} ) & ( 4 ) \\ {a}_{y} ( t , x , y , z ) = {\sum }_{ω} {\sum }_{{k}_{x}} {\sum }_{{k}_{y}} i \frac{{k}_{y}}{ρ} ( A ( ω , {k}_{x} , {k}_{y} ) {e}^{i ( ω t - {k}_{x} x - {k}_{y} y + {k}_{z} z )} - R ( ω , {k}_{x} , {k}_{y} ) A ( ω , {k}_{x} , {k}_{y} ) {e}^{i ( ω t - {k}_{x} x - {k}_{y} y - {k}_{z} z )} {e}^{- i 2 {k}_{z} d} ) & ( 5 )\end{matrix}$$

where A is the amplitude of a single-frequency plane-wave component, R is the reflectivity of the water surface for that plane wave, and d is the multi-component receiver depth.

Equations (2), (4) and (5) indicate that conversion from p to aₓ, or a_{y} can be achieved in the F-K (frequency-wave number) or F-P (frequency-slope) domain by multiplying p with kₓ/p or k_{y}/p because the up-going and down-going waves in aₓ and a_{y} have substantially the same polarity as those in p. Here, the term “substantially” is used to qualify the same polarity assertion that is true for the signal but is affected by noise presence.

The conversion from p to aₓ or a_{y} is thus equivalent to performing an obliquity correction (i.e., an obliquity-dependent scaling to correct sensitivity difference of the geophone to the incoming waves with different incident angles) and then differentiating in time. In order to obtain equivalent aₓ and a_{y} data (i.e., horizontal components of the equivalent acceleration data), a sparse τ-P transformation is applied to the pressure data. A τ-p transformation under the sparse constraint inverts as sparse as possible a τ-P model to fit the data. An obliquity correction and a differential in the F-P (slope) domain are then applied to the transformed p data. The τ-P transformation transforms pressure data in the τ-p domain; applying a one dimensional Fast Fourier transform to pressure data in the τ-p domain yields pressure data in the F-P domain. If the sensor-acquired data is velocity data, the equivalent aₓ and a_{y} data are then integrated to obtain equivalent vₓ and v_{y} data.

Converting p data into a_{z} equivalent data is more complex due to the polarity difference in the down-going waves between p and a_{z} (i.e., the sign difference of the second term of the plane-wave expansion in equations 2 and 3). A de-ghosting method may be applied first to separate p data into a ghost-free part and a ghost part. For example, as de-ghosting method, it may be used the method described in the article “3D joint deghost and crossline interpolation for marine single-component streamer data” by Wang, P. et al., 84^{th} Annual International Meeting, SEG, Expanded Abstracts, 3594-3598 (the contents of which is incorporated herewith by reference in its entirety). P-like data may then be generated by flipping polarity of the ghost part and then adding the ghost-free part to the ghost part with flipped polarity. The p-like data is then processed similarly to the manner in which the p data is processed to obtain the equivalent aₓ or a_{y} data. That is, an obliquity correction and a time differential in the F-P (slope) domain is applied to the p-like data to obtain equivalent a_{z} data, which includes substantially similar signal (phase-wise and amplitude-wise) as measured (i.e., sensor-acquired) a_{z}. As in case of aₓ and a_{y} described above, a τ-P transformation is then employed. If the sensor-acquired data is velocity data, the equivalent a_{z} data is then integrated to obtain equivalent v_{z} data.

Returning now to FIG. 1, method 100 then includes de-noising the sensor-acquired three-dimensional acceleration or the sensor-acquired velocity data using the equivalent acceleration data at 130. In other words, the equivalent acceleration data (integrated, if necessary, to equivalent velocity data) provides a reference for attenuating noise in the sensor-acquired data. If the seismic data includes the sensor-acquired velocity data, the method includes time-integrating the equivalent acceleration data to obtain equivalent velocity data.

De-noising may be performed using a cooperative de-noising method that attenuates energy distribution inconsistencies between the sensor-acquired data and the equivalent data, while maintaining the similar energy portions. The energy inconsistencies may be identified and separated using a high angular resolution complex wavelet transform (HARCWT) applied to sensor-acquired data and to equivalent data. The HARCWT is described in the article, “Shear noise attenuation and PZ matching for OBN data with a new scheme off complex wavelet transform,” by Peng et al. (which was previously mentioned and incorporated by reference). Applying HARCWT yields a set of complex coefficients for the sensor-acquired data and a set of coefficients for the equivalent data. Each complex coefficient corresponds to a wavelet. Phases and/or amplitudes in pairs of complex coefficients (one from the set of complex coefficients for the sensor-acquired data and another from the set of coefficients for the equivalent data) corresponding to the same wavelet are compared. If differences larger than predetermined thresholds are observed, the complex coefficient from the set corresponding to the sensor-acquired data is attenuated. A reverse HARCWT is then applied to the attenuated sensor-acquired data.

Method 100 may also include filtering pressure data to eliminate low-frequency noise. For example, a conservative low-cut filter for frequencies less than 2.5 Hz may be applied.

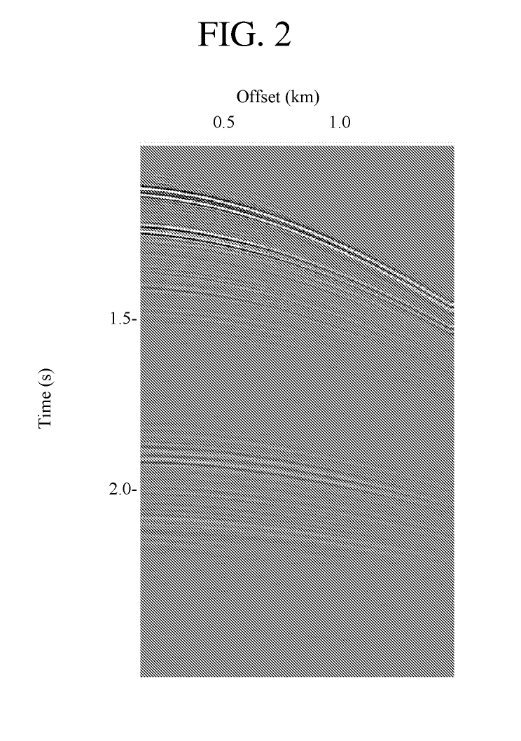

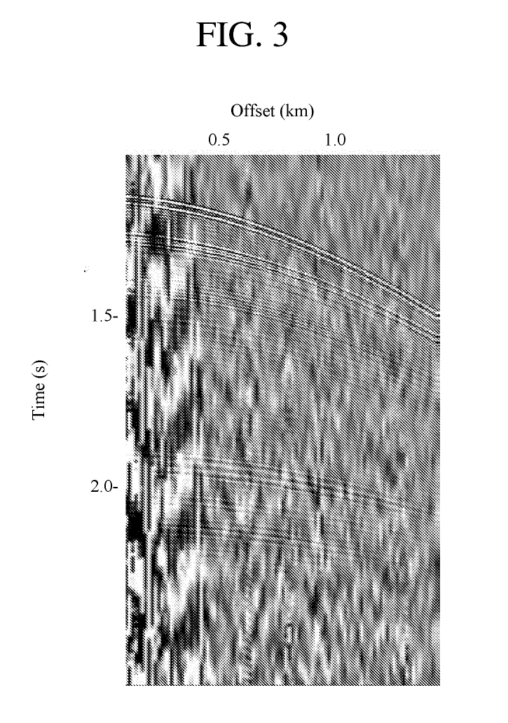

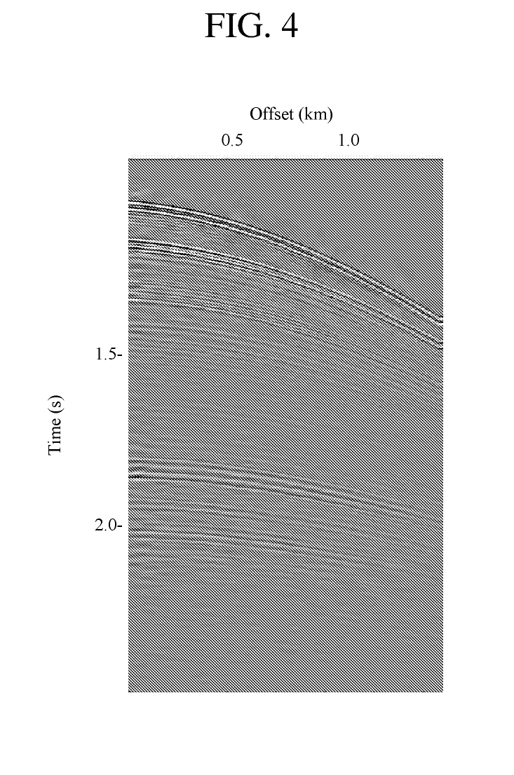

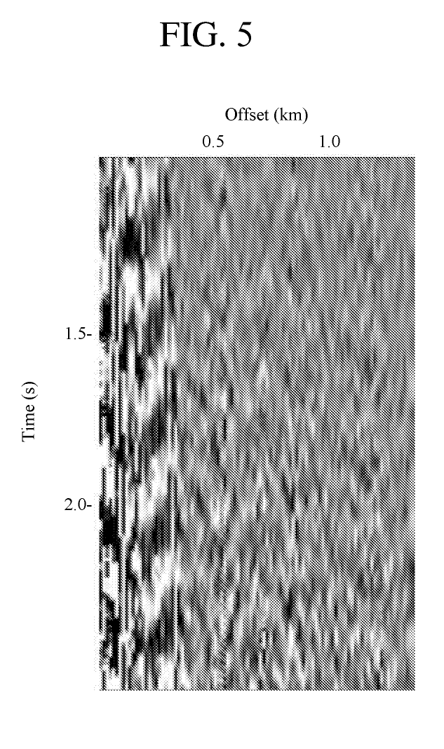

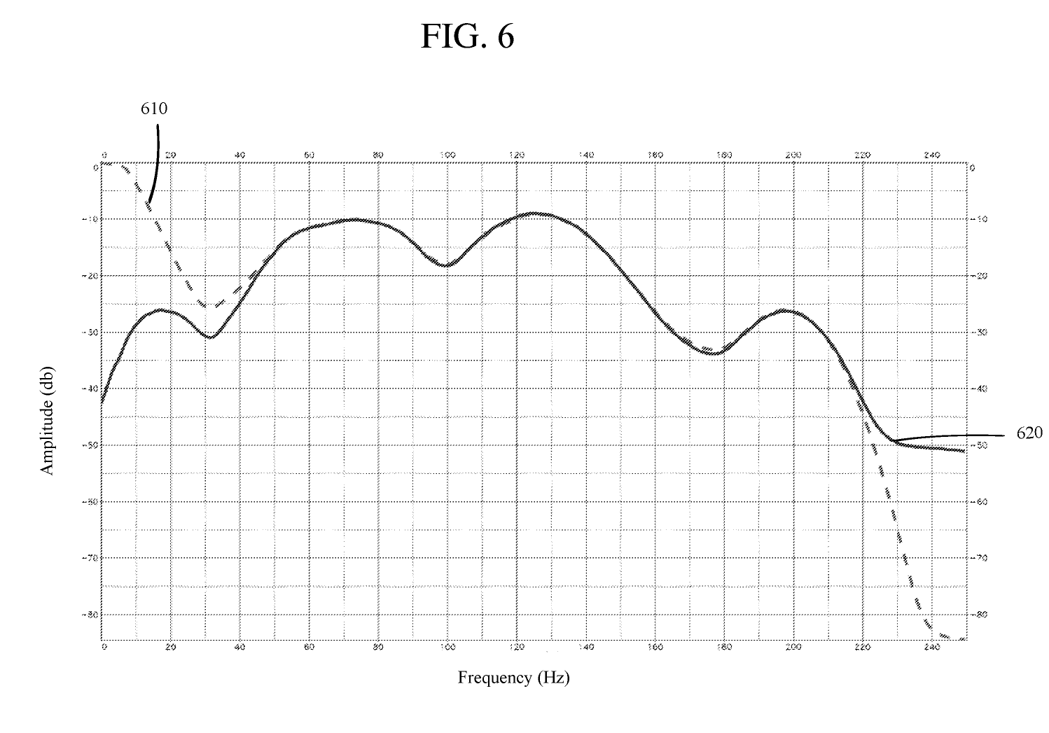

Results of applying the above-described methods to real data is illustrated in FIGS. 2-9. FIGS. 2-5 are two-dimensional graphs in which the horizontal axis is Offset in km and the vertical axis is time in s (increasing down) and in which the shades of gray are used to illustrate signal amplitude. FIG. 2 illustrates a shot gather of equivalent a_{z} data obtained from pressure data. FIG. 3 illustrates the corresponding sensor-acquired a_{z} data. FIG. 4 illustrates the de-noised sensor-acquired a_{z} data (i.e., the output of the method). FIG. 5 illustrates the removed noise. FIG. 6 is a two-dimensional graph of amplitude (in dB) versus frequency in Hz, and illustrates spectra of sensor-acquired a_{z} data before de-noising, line 610, and after de-noising, line 620.

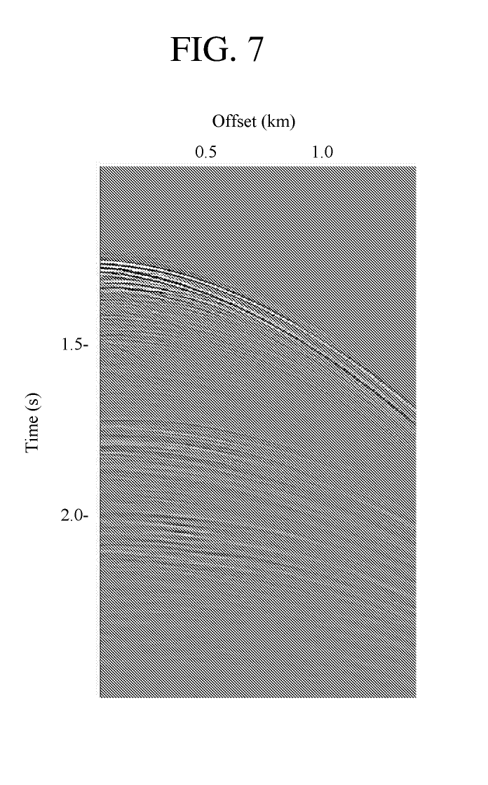

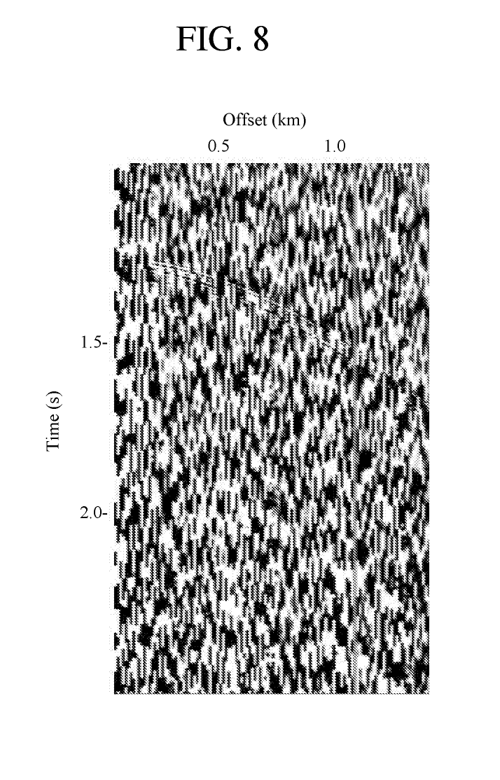

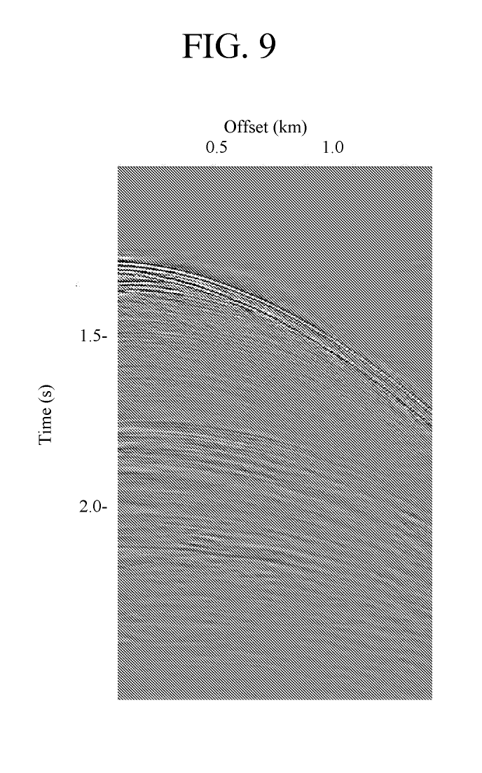

In the same format as FIGS. 2-4, FIGS. 7-9 refer to a_{y} data. FIG. 7 illustrates a shot gather of equivalent a_{y} data obtained from pressure data. FIG. 8 illustrates the corresponding sensor-acquired a_{y} data. FIG. 9 illustrates the de-noised sensor-acquired a_{y} data.

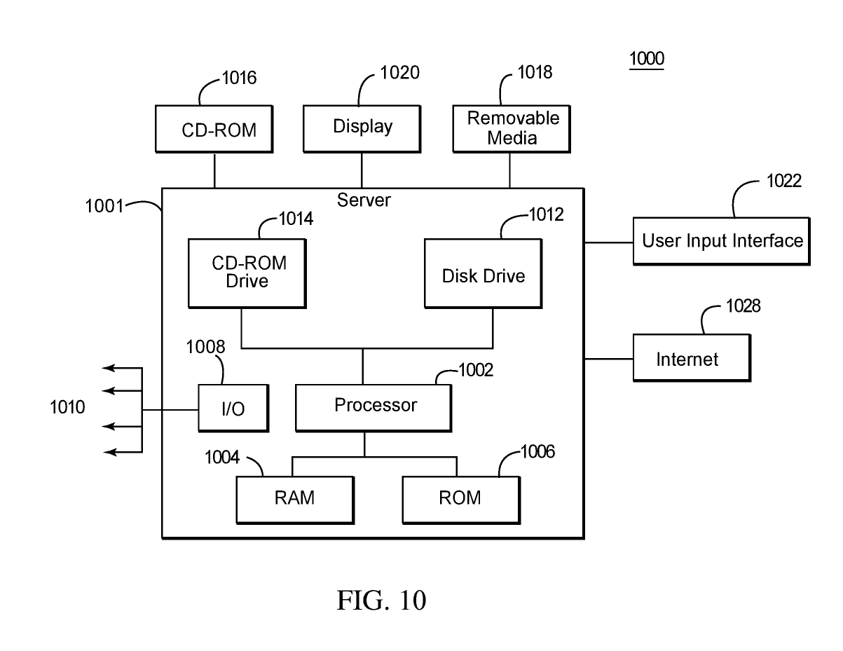

FIG. 10 illustrates a block diagram of a seismic data processing apparatus 1000 according to an embodiment. Apparatus 1000 is configured to perform noise attenuation in multi-sensor streamer data as discussed above. Hardware, firmware, software or a combination thereof may be used to perform the various steps and operations. Processing device 1000 may include server 1001 having a central processor unit (CPU) 1002 having one or more processors. CPU 1002 is coupled to a random access memory (RAM) 1004 and to a read-only memory (ROM) 1006. ROM 1006 may also be other types of storage media to store programs, such as programmable ROM (PROM), erasable PROM (EPROM), etc. Methods according to various embodiments described in this section may be implemented as computer programs (i.e., executable codes) non-transitorily stored on RAM 1004 or ROM 1006. CPU 1002 may communicate with other internal and external components through input/output (I/O) circuitry 1008 and bussing 1010, which are configured to obtain the seismic data.

CPU 1002 is configured to convert the pressure data into equivalent acceleration data, and to de-noise the sensor-acquired acceleration or the sensor-acquired velocity data using the equivalent acceleration data. CPU 1002 may also be configured to time-integrate the equivalent acceleration data to obtain equivalent velocity data. Further, CPU 1002 may be configured to de-noise the sensor-acquired acceleration or the sensor-acquired velocity data using a cooperative de-noising method using the HARCWT as already described in this section. CPU 1002 may also be configured to filter the pressure data before converting it into equivalent acceleration data.

Server 1001 may also include one or more data storage devices, including disk drive 1012, CD-ROM drive 1014, and other hardware capable of reading and/or storing information (e.g., seismic data before and after processing), such as a DVD, etc. In one embodiment, software for carrying out the above-discussed steps may be stored and distributed on a CD-ROM 1016, removable media 1018 or other form of media capable of storing information. The storage media may be inserted into, and read by, devices such as the CD-ROM drive 1014, disk drive 1012, etc. Server 1001 may be coupled to a display 1020, which may be any type of known display or presentation screen, such as LCD, plasma display, cathode ray tube (CRT), etc. Server 1001 may control display 1020 to exhibit images generated using seismic data such as FIGS. 2-9. A user input interface 1022 is provided, including one or more user interface mechanisms such as a mouse, keyboard, microphone, touchpad, touch screen, voice-recognition system, etc.

Server 1001 may be coupled to other computing devices, such as the equipment of a vessel, via a network. The server may be part of a larger network configuration as in a global area network (GAN) such as the Internet 1028, which allows ultimate connection to various landline and/or mobile devices.

The disclosed exemplary embodiments provide methods and devices for noise attenuation in seismic data, including pressure data and acceleration or velocity data, which have been acquired simultaneously by multi-component sensors in streamers. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

1. A noise attenuation method comprising:
obtaining seismic data including pressure data and sensor-acquired acceleration or sensor-acquired velocity data as acquired simultaneously by multi-component sensors in streamers;
converting the pressure data into equivalent acceleration data; and
de-noising the sensor-acquired acceleration or the sensor-acquired velocity data using the equivalent acceleration data.

2. The method of claim 1, wherein if the seismic data includes the sensor-acquired velocity data, the method includes time-integrating the equivalent acceleration data to obtain equivalent velocity data.

3. The method of claim 1, wherein the converting of the pressure data into the equivalent acceleration data includes:
decomposing the pressure data in a primary portion and a ghost portion;
flipping polarity of the ghost portion;
obtaining p-like data by adding the primary portion and the ghost portion with flipped polarity;
generating horizontal components of the equivalent acceleration data from the pressure data; and
generating a vertical component of the equivalent acceleration data from the p-like data.

4. The method of claim 3, wherein the horizontal components and the vertical component are generated by applying a sparse τ-P transformation, followed by an obliquity correction and a differential in an F-P domain to the pressure data and to the pressure-like data, respectively.

5. The method of claim 1, wherein the de-noising is performed using a cooperative denoising method including:
applying a high angular resolution complex wavelet transform (HARCWT) to sensor-acquired data and to equivalent data, to obtain a sensor-acquired data representation and an equivalent data representation, respectively, in a wavelet basis; and
attenuating at least one first complex coefficient of the sensor-acquired data representation that differs, according to a first criterion, from a complex coefficient of the equivalent data representation corresponding to a same wavelet as the at least one first complex coefficient; and
applying a reverse HARCWT to attenuated sensor-acquired data;
wherein the sensor-acquired data is the sensor-acquired acceleration or velocity data included in the seismic data, and the equivalent data is the equivalent acceleration data or equivalent velocity data obtained by time-integrating the equivalent acceleration data, respectively.

6. The method of claim 5, wherein
the first criterion is that a difference between a phase of the at least one first complex coefficient, and a phase of the corresponding complex coefficient exceeds a predetermined threshold.

7. The method of claim 5, wherein the first criterion is that an amplitude of the at least one first complex coefficient is larger than an amplitude of the corresponding complex coefficient by more than a predetermined value.

8. The method of claim 5, wherein any complex coefficient of the sensor-acquired data representation that differs, according to the first criterion, from a complex coefficient of the equivalent data representation corresponding to a same wavelet is attenuated.

9. The method of claim 1, wherein before being converted into equivalent acceleration data, the pressured data is filtered to remove low frequency components.

10. A data processing apparatus, comprising:
an interface configured to obtain seismic data including pressure data and sensor-acquired acceleration or sensor-acquired velocity data as acquired simultaneously by multi-component sensors in streamers; and
a data processing unit configured
to convert the pressure data into equivalent acceleration data, and
to de-noise the sensor-acquired acceleration or the sensor-acquired velocity data using the equivalent acceleration data.

11. The apparatus of claim 10, wherein if the seismic data includes the sensor-acquired velocity data, the data processing unit is further configured to time-integrate the equivalent acceleration data to obtain equivalent velocity data.

12. The apparatus of claim 10, wherein the data processing unit converts the pressure data into the equivalent acceleration data by:
decomposing the pressure data in a primary portion and a ghost portion;
flipping polarity of the ghost portion;
obtaining p-like data by adding the primary portion and the ghost portion with flipped polarity;
generating horizontal components of the equivalent acceleration data from the pressure data; and
generating a vertical component of the equivalent acceleration data from the p-like data.

13. The apparatus of claim 12, wherein the data processing unit generates the horizontal components and the vertical component by applying a sparse τ-P transformation, followed by an obliquity correction and a differential in an F-P domain to the pressure data and to the pressure-like data, respectively.

14. The apparatus of claim 10, wherein the data processing unit de-noises the sensor-acquired acceleration or the sensor-acquired velocity data using a cooperative denoising method including:
applying a high angular resolution complex wavelet transform (HARCWT) to sensor-acquired data and to equivalent data, to obtain a sensor-acquired data representation and an equivalent data representation, respectively, in a wavelet basis; and
attenuating at least one first complex coefficient of the sensor-acquired data representation that differs, according to a first criterion, from a complex coefficient of the equivalent data representation corresponding to a same wavelet as the at least one first complex coefficient,
wherein the sensor-acquired data is the sensor-acquired acceleration or the sensor-acquired velocity data included in the seismic data, and the equivalent data is the equivalent acceleration data or equivalent velocity data obtained by time-integrating the equivalent acceleration data, respectively.

15. The apparatus of claim 14, wherein
the first criterion is that a difference between a phase of the at least one first complex coefficient, and a phase of the corresponding complex coefficient exceeds a predetermined threshold.

16. The apparatus of claim 14, wherein the first criterion is that an amplitude of the at least one first complex coefficient is larger than an amplitude of the corresponding complex coefficient by more than a predetermined value.

17. The apparatus of claim 14, wherein any complex coefficient of the sensor-acquired data representation that differs, according to the first criterion, from a complex coefficient of the equivalent data representation corresponding to a same wavelet is attenuated.

18. The apparatus of claim 10, wherein the data processing unit is further configured to filter the pressured data such that to remove low frequency components before converting the pressured data in the equivalent acceleration data.

19. A computer readable recording medium non-transitorily storing executable codes which, when executed on a computer make the computer perform a noise attenuation method comprising:
obtaining seismic data including pressure data and sensor-acquired acceleration or sensor-acquired velocity data as acquired simultaneously by multi-component sensors in streamers;
converting the pressure data into equivalent acceleration data; and
de-noising the sensor-acquired acceleration or the sensor-acquired velocity data using the equivalent acceleration data.

20. The computer readable recording medium of claim 19, wherein
the de-noising is performed using a cooperative denoising method,
the converting of the pressure data into the equivalent acceleration data includes obtaining p-like data by adding a primary portion of the pressure data and a ghost portion of the pressure data with flipped polarity and generating horizontal components of the equivalent acceleration data from the pressure data, and a vertical component of the equivalent acceleration data from the p-like data, and
the horizontal components and the vertical component are generated by applying a sparse τ-P transformation, followed by an obliquity correction and a differential in an F-P domain to the pressure data and to the pressure-like data, respectively.
